(19) United States
(12) Patent Application Publication
(10) Pub. No.: US 2026/0246298 A1
(43) Pub. Date: Aug. 20, 2026

(54) WIRELESS POWER CONDUCTION FOR POWER TOOLS

(71) Applicant: Milwaukee Electric Tool Corporation, Brookfield, WI (US)

(72) Inventors: Luke J. Skinner, West Bend, WI (US); John Reeve, Brookfield, WI (US); Carl B. Westerby, Menomonee Falls, WI (US)

(21) Appl. No.: 19/540,327

(22) Filed: Feb. 13, 2026

Related U.S. Application Data
(60) Provisional application No. 63/758,712, filed on Feb. 14, 2025.

(51) Int. Cl. H02J 50/10; H02J 50/12; H02M 3/158

(52) U.S. Cl. CPC H02J 50/10; H02J 50/12; H02M 3/158

(57) ABSTRACT

A power tool includes a tool body with a power source. A working component is rotatably coupled to the tool body to rotate about an axis. An electronic component is supported on the working component to rotate with it. A wireless power transfer system transmits power from the power source to the electronic component. The system includes a first circuit on the tool body with a first coil and power conversion module. The power conversion module generates AC current in the first coil to produce a magnetic field. A second circuit on the working component includes a second coil that interacts with the magnetic field, generating AC current that powers the electronic component.

### CROSS-REFERENCE TO RELATED APPLICATIONS

This application claims priority to U.S. Provisional Application No. 63/758,712, filed on Feb. 14, 2025, which is incorporated herein by reference in its entirety.

### BACKGROUND

The present disclosure relates to systems and methods for wirelessly transferring power between a stationary component and a rotatable component in a power tool. Conventional mechanical tools face significant challenges when integrating electronic components to their working heads. Traditional solutions, such as wired power delivery using slip rings, are prone to mechanical wear and high maintenance requirements. There is a growing need for enabling power and data transfer to the working head without the constraints of physical wiring and mechanical contact.

### SUMMARY

A power tool, as described herein, may have various configurations. The power tool may include a tool body, a working component, and a wireless power transfer system.

In some aspects, a power tool can include a tool body including a power source. A working component can be rotatably coupled to the tool body to rotate about an axis relative to the tool body. An electronic component can be supported on the working component to rotate with the working component relative to the tool body. A wireless power transfer system can transmit a power signal from the power source to the electronic component to power the electronic component. The wireless power transfer system can include a first circuit supported on the tool body and including a first coil and first power conversion module. The first power conversion module can be powered by the power source to generate a first AC current in the first coil to produce a magnetic field. The wireless power transfer system can include a second circuit supported on the working component and including a second coil. The second coil can interact with the magnetic field and generate a second AC current in the second circuit that powers the electronic component.

In some examples, the second circuit can include a second power conversion module to convert the second AC current to a DC current.

In some examples, the electronic component can include at least one of a lighting module or a sensor.

In some examples, the first circuit can include a first communications module and the second circuit can include a second communications module.

In some examples, the tool body can include a housing and an actuator supported by the housing. The working component can include a yoke rotatably coupled to the tool body and a pair of jaws movably coupled to the yoke. The electronic component can be supported on the jaws.

In some examples, the actuator can be a hydraulic actuator defining a longitudinal axis. The first coil and the second coil can be arranged concentrically with the hydraulic actuator about the longitudinal axis.

In some examples, the hydraulic actuator can include a cylinder and a rod. The first coil can surround the cylinder and the second coil can surround the rod.

In some examples, the first coil and the second coil can be axially aligned with one another along the longitudinal axis of the hydraulic actuator.

In some examples, the tool body can include a housing and a controller supported on the housing. The working component can include a cable reel rotatably coupled to a housing and a cable that is wound on the cable reel. The electronic component can be supported on a free end of the cable.

In some examples, the power tool can further include a trigger supported on the tool body. The wireless power transfer system can initiate transmission of the power signal in response to actuation of the trigger.

In some examples, actuation of the trigger can cause the first power conversion module to generate the first AC current in the first coil.

In some examples, the power tool can further include a primary controller supported on the tool body. The primary controller can receive an input signal from the trigger and send a control signal to the first power conversion module to initiate generation of the first AC current.

In some examples, the power tool can further include an actuator supported on the tool body. Actuation of the trigger can cause operation of the actuator and transmission of the power signal to the electronic component.

In some aspects, a power tool can include a tool body including a power source and a primary controller. A working component can be rotatably coupled to the tool body to rotate about an axis relative to the tool body. An electronic component can be supported on the working component to rotate with the working component relative to the tool body. A wireless transfer system can transmit signals between the primary controller and the electronic component. The wireless transfer system can include a first circuit supported on the tool body and including a first coil. The first circuit can receive a control signal from the primary controller and generate a current in the first coil to produce a magnetic field. The wireless transfer system can include a second circuit supported on the working component and including a second coil. The second coil can interact with the magnetic field and induce a current in the second circuit to operate the electronic component based on the control signal from the primary controller.

In some examples, the second circuit can include a power pick-up unit to convert the induced current to a DC current for powering the electronic component.

In some examples, the first circuit can include a communication module that receives the control signal from the primary controller and converts the control signal to an analog signal supplied to the first coil.

In some examples, the second circuit can include a secondary control unit that processes signals received from the first circuit and generates control outputs for the electronic component.

In some examples, the wireless transfer system can be configured for bidirectional communication. The secondary control unit can transmit data from the electronic component to the primary controller by modulating a signal in the second coil that induces a corresponding signal in the first coil for reception by the primary controller.

In some aspects, a method of operating a power tool can include rotatably coupling a working component to the tool body to rotate about an axis relative to the tool body. The method can include supporting an electronic component on the working component to rotate with the working component relative to the tool body. The method can include transmitting a first power signal from the power source to the electronic component via a wireless power transfer system to power the electronic component by generating a first AC current in a first coil of a first circuit supported on the tool body using a first power conversion module powered by the power source to produce a magnetic field. The magnetic field can interact with a second coil of a second circuit supported on the working component to generate a second AC current in the second circuit that powers the electronic component.

In some examples, the method can further include transmitting the first power signal when the working component is in a first rotational position relative to the tool body. The method can include rotating the working component from the first rotational position to a second rotational position about the axis relative to the tool body. The method can include transmitting a second wireless signal from the power source to the electronic component via the wireless power transfer system when the working component is in the second rotational position.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a perspective view of power tool according to aspects of the present disclosure.

FIG. 2 is a diagrammatic view of a wireless power transfer system of the power tool of FIG. 1.

FIG. 3 is a diagrammatic view of a circuit arrangement of the wireless power transfer system of FIG. 2.

FIG. 4 is an axonometric view of a coil arrangement of the wireless power transfer system of FIG. 2.

FIG. 5 is a side view of example of the power tool of FIG. 1 configured as a hydraulic tool having a lighting or indicating module supported on the working head.

FIG. 6 is a side view of another example of the power tool of FIG. 1 configured as a hydraulic tool having a sensor supported on the working head.

FIG. 7 is a front view of example of the power tool of FIG. 1 configured as an imaging tool having sensor arrangement supported on the working head.

### DETAILED DESCRIPTION

Integrating electronic components into a working head that can move (e.g., rotate) relative to main housing can, for example, provide improved lighting and sensing capabilities for power tools. With conventional systems, mechanical slip rings can be used to allow power or other signals to be transferred between a main housing (e.g., tool body that supports a control unit) and an electronic device mounted on working head that is rotatable relative to the main housing. However, such system requires increased maintenance to maintain physical electrical connections, and correspondingly, typically increase tool size to account for the additional electrical connection between the main housing and the working head. These types of slip ring arrangements typically require brushes that maintain contact with the outer surface of a rotating metal ring. As the ring rotates, the brush conducts electric signals to the metal ring and establishes electrical connections. While functional, conventional slip ring poses several drawbacks including structural complexity, increased maintenance, and high cost. Moreover, the sensitive nature of such connections also limits the use of such systems in many types of power tools that are used in high impact and vibrational environments. Due to these complications, conventional tools typically position electronic components (sensors, lights, etc.) on the housing (e.g. main tool body) rather than the working head because implementing the electronic component requires more complex and fragile wired solutions like slip rings.

Additionally, because electronic components are supported on the housing in conventional tool arrangements, the electronic components are positioned away from the working head, which may result in less than optimal performance or reduced functionality. For example, in the case of lighting elements, light emitted near the housing may be at least partially blocked by the working head, in particular at location between jaws where crimping occurs, which can also make workpiece alignment within the jaws more difficult. As another example, output force (crimp force), cut quality, and other performance metrics must be measured indirectly, for example, via pressure measurements of the hydraulic fluid in the cylinder.

Aspects of the present disclosure can address some or all of these shortcomings of conventional tools. According to the disclosure, a wireless power transfer system can be used to transmit power, communication, or other signals between a tool body and a movable component on the tool body. In particular a first coil is coupled to the tool body and a second coil is coupled to the rotatable component. Current can be sent though the first coil to generate a current in the second coil, thereby transferring power or electrical signals therebetween. Correspondingly the current induced in the second coil can be used to power or communicate with an electronic component mounted on the rotatable component. This allows reliable and efficient power transfer to the rotatable working head without physical contact, thereby overcoming the limitations of mechanical wear, noise production, and maintenance challenges associated with wired slip rings.

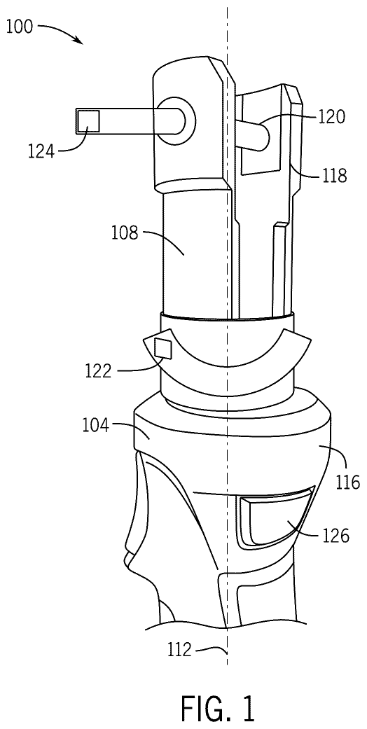

FIG. 1 illustrates an example of a power tool 100, in accordance with the present disclosure. Although the example implementation described herein references a power tool, the features of this disclosure can be implemented in other similar tools, such as cutting, crimping tools or punching tools. In addition, any suitable size, shape or type of elements or materials could be used. The power tool 100 includes a stationary component 104 and a movable component 108 that is movably coupled to the stationary component 104 to perform an operation on a work piece. The movable component 108 can be configured to move relative to the stationary component 104 in various ways. For example, the movable component 108 can be configured as a rotatable component that is rotatably coupled to the stationary component 104. In such configurations, the rotatable connection enables the movable component 108 (hereinafter also referred to as the rotatable component 108) to rotate relative to the stationary component 104 about a rotational axis 112. In other examples, the movable component 108 can be configured to translate, pivot, or otherwise move relative to the stationary component 104. For purposes of illustration, the following description primarily references the rotatable component 108, though it should be understood that the principles described herein are applicable to other types of movable components as well.

In the illustrated example, the stationary component 104 is configured as a tool body 116 of the power tool 100. Correspondingly, the rotatable component 108 is configured as a working component 118 (e.g., a working head or output assembly) that performs the desired work operation. For example, the working component 118 can be configured to engage with a workpiece to perform the work operation (e.g., via a tool bit, such as a drill bit, blade, crimping die, etc.). For example, the working component 118 can be crimping jaws that move relative to one another to engage with a workpiece and perform a crimping operation. In other examples, the stationary component 104 can be configured as a base unit, a handle assembly, a motor housing, a control module housing, or a mounting bracket that remains fixed during operation. The movable component 108 can alternatively be configured as a cutting head, a grinding wheel assembly, a polishing pad holder, a sanding disc carrier, a drill chuck, a saw blade guard, a router bit holder, a cable reel, a wire spool, an inspection probe, or other output assemblies that move relative to the stationary component 104 during use. In some configurations, the movable component 108 can be a pivoting arm, a reciprocating blade assembly, or an oscillating head that moves in a non-rotational manner relative to the stationary component 104. The working component 118 can integrate electronic components 120 (e.g., sensors, lighting modules, readers, cameras, indicators, or communication devices) that are wirelessly powered through the disclosed system. In some examples, as illustrated by FIG. 1, there can be a hall effect sensor 122 in the working component 118 and a magnet 124 in a clevis pin latch to detect that the latch is seated properly.

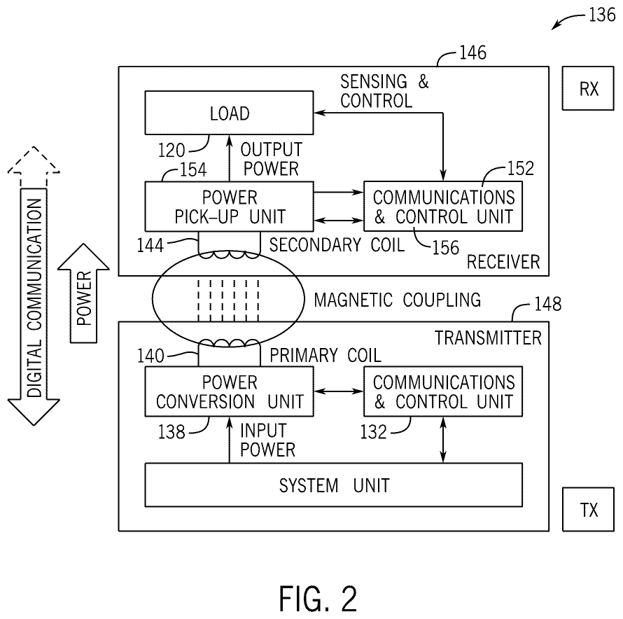

To operate the power tool 100, a user interface 126 (e.g., a trigger, button, dial, touchscreen, etc.) is coupled to the stationary component 104. The user interface 126 can be manipulated by a user to operate the power tool 100 and perform the work operation. In some configurations, the user interface 126 can include a trigger supported on the tool body 116 that can be actuated by a user to initiate operation of the power tool 100. For example, actuating the user interface 126 can control operation of an actuator 128 (e.g., a motor, linear actuator, hydraulic actuator, etc.) that is coupled to the stationary component 104. Herein, the actuator 128 is a hydraulic actuator 130. In some cases, as seen in FIGS. 1-2, the user interface 126 can receive an input from a user and send a signal to a primary controller 132 of the power tool 100. In turn, the primary controller 132 can send a signal to cause operation of the power tool in accordance with the user input (e.g., to operate the actuator 128, to turn on a light, etc.). As illustrated, the primary controller 132 can be coupled to the stationary component 104. The primary controller 132 can include one or more processors, memory devices, and associated circuitry configured to execute control algorithms and manage power distribution throughout the power tool 100. In some implementations, the primary controller 132 can monitor operational parameters such as battery charge level, motor current draw, actuator position, and temperature conditions. The primary controller 132 can also be configured to communicate with external devices, such as mobile phones, tablets, or cloud-based systems, via wired or wireless communication protocols. In certain configurations, the user interface 126 can include visual indicators (e.g., LEDs, display screens) or audible indicators (e.g., speakers, buzzers) to provide feedback to the user regarding the operational status of the power tool 100.

As mentioned above, an electronic component can be mounted to a rotatable component to provide increased functionality, for example, improved lighting or sensing capability. Various types of electronic components can be used. For example, a lighting component can be secured to a rotatable component to emit light closer to where the work operation is performed. In this way, the workpiece or work area can be better illuminated. As another example sensors (e.g., image, current, pressure, or other types of sensors) can be mounted to the rotatable component to allow for direct measuring of one or more working parameters. As shown in FIG. 1, the power tool includes an electronic component 120 that is coupled to the rotatable component 108 so that the electronic component 120 moves with the rotatable component 108 relative to the stationary component 104. The electronic component 120 can include various configurations depending on the intended application. For instance, the electronic component 120 can include strain gauges configured to measure deformation or stress applied to the working component 118 during operation. In other examples, the electronic component 120 can include accelerometers or gyroscopes to detect orientation, vibration, or movement patterns of the rotatable component 108. Temperature sensors can be incorporated as the electronic component 120 to monitor thermal conditions at the working component 118, which can be useful for detecting overheating conditions or verifying proper operation. Proximity sensors or distance measuring devices can be included to detect the presence or position of a workpiece relative to the working component 118. In some configurations, the electronic component 120 can include multiple sensor types arranged in an array or distributed across different locations on the rotatable component 108 to provide comprehensive monitoring of operational conditions. The electronic component 120 can also include data storage elements configured to log operational data, usage statistics, or maintenance records associated with the working component 118. In certain implementations, the electronic component 120 can include wireless communication transceivers that enable direct communication with external devices independent of the primary controller 132.

In general, electronic components require an electrical source to perform their desired operation. In accordance with the disclosure, an electronic signal (e.g., a power signal, communication signal, etc.) can be provided from a stationary component to a rotatable component, or vice versa, via a wireless transfer system. With additional reference to FIGS. 2-4, the power tool 100 includes a wireless transfer system 136 to transfer wireless signals between the tool body 116 and the electronic component 120 of the working head. The wireless transfer system 136 employs electromagnetic induction principles to achieve contactless signal transmission across the rotatable interface between the stationary component 104 and the rotatable component 108. This approach eliminates the need for physical electrical conductors that would otherwise be subject to wear, fatigue, or disconnection during rotation of the working component 118. The wireless transfer system 136 can operate continuously regardless of the angular position of the rotatable component 108 relative to the stationary component 104, thereby providing uninterrupted power delivery and communication capability throughout the full range of rotational motion. For example, the wireless transfer system 136 can transmit a first power signal from the power source to the electronic component 120 when the working component 118 is in a first rotational position relative to the tool body 116. The working component 118 can then be rotated from the first rotational position to a second rotational position about the axis relative to the tool body 116, and the wireless transfer system 136 can transmit a second wireless signal from the power source to the electronic component 120 when the working component 118 is in the second rotational position. As described in greater detail below, the wireless transfer system 136 is configured to control the transfer of wireless signals, including power or communication signals, between the stationary component 104 and the rotatable component 108. The wireless transfer system 136 can be configured to operate at various frequencies and power levels depending on the requirements of the electronic component 120 being powered. For low-power applications such as LED lighting modules, the wireless transfer system 136 can be optimized for efficiency at relatively low power levels. For higher-power applications such as active sensors or communication transceivers, the wireless transfer system 136 can be configured to deliver increased power while maintaining acceptable efficiency levels. The wireless transfer system 136 can also incorporate feedback mechanisms to dynamically adjust power delivery based on the load requirements of the electronic component 120.

For example, in accordance with a first signal (e.g., a control signal) from the primary controller 132 of the power tool 100, the wireless transfer system 136 can transmit a second signal from the stationary component 104 to the rotatable component 108. The first signal can be generated in response to a user input received at the user interface 126. For instance, actuation of a trigger, depression of a button, rotation of a dial, or other manipulation of the user interface 126 can cause the primary controller 132 to generate the first signal and initiate wireless power transmission to the rotatable component 108. In some cases, the wireless power transmission can be initiated automatically upon activation of the power tool 100, such as when the user actuates the main operating trigger to perform a work operation. In such configurations, the electronic component 120 can be powered concurrently with operation of the actuator 128, thereby providing lighting, sensing, or other functionality during the work operation. Accordingly, actuation of the trigger can cause both operation of the actuator 128 and transmission of the power signal to the electronic component 120. In other cases, the wireless power transmission can be controlled independently of the main tool operation via a separate user input, such as a dedicated switch, button, or other control element on the tool body 116. This independent control can allow a user to selectively activate the electronic component 120 without initiating the primary work operation, which can be useful for illuminating a work area prior to performing a crimping or cutting operation, or for activating sensors to inspect a workpiece before engaging the actuator 128. The wireless power transfer system 136 can initiate transmission of the power signal in response to actuation of the trigger. In some implementations, the primary controller 132 can receive an input signal from the trigger and send a control signal to the first power conversion module 138 to initiate generation of the first AC current in the first coil 140. Actuation of the trigger can cause the first power conversion module 138 to generate the first AC current in the first coil 140. The second signal can be a power signal configured to energize the electronic component 120, a data signal configured to convey operational instructions or configuration parameters, or a combined signal that carries both power and data simultaneously. Correspondingly, in some cases, the wireless transfer system 136 can transmit a third signal from the rotatable component 108 to the stationary component 104. The third signal can carry sensor data, status information, diagnostic data, or acknowledgment signals from the electronic component 120 back to the primary controller 132. This bidirectional communication capability enables closed-loop control of the electronic component 120 and allows the primary controller 132 to monitor the operational status of components mounted on the rotatable component 108 in real time.

Still referring to FIGS. 1-4, the wireless transfer system 136 of the power tool 100 uses magnetic coupling to transfer signals through an AC voltage source from the stationary component 104 to the rotatable component 108, or vice versa. Accordingly, the wireless transfer system 136 allows data or power to be sent bi-directionally between the stationary component 104 and rotatable component 108, enabling real-time communication for advanced features such as sensors, position detection systems, and feedback mechanisms. The magnetic coupling approach provides several advantages over conventional wired connections, including elimination of physical wear at the rotational interface, reduced maintenance requirements, and improved reliability in high-vibration operating environments. The wireless transfer system 136 can maintain consistent signal transmission regardless of the angular position of the rotatable component 108, which can provide uninterrupted operation throughout the full range of rotational motion. Additionally, the absence of physical electrical contacts at the rotational interface allows for simplified sealing arrangements, which can improve dust and moisture resistance of the power tool 100.

The wireless transfer system 136 sends signals between the stationary component 104 and the rotatable component 108 using coils mounted at the rotatable connection therebetween. In particular, a first coil 140 is coupled to the stationary component 104 (e.g., within the tool body 116), and a second coil 144 is coupled to the rotatable component 108 (e.g., within the working component 118). The first coil 140 and the second coil 144 are axially aligned (e.g., to be coaxial with one another about the rotational axis 112) to facilitate mutual inductive coupling therebetween, enabling power to be transferred from the stationary component 104 and the rotatable component 108. The coaxial alignment of the first coil 140 and the second coil 144 can help maintain substantially constant magnetic flux linkage between the coils as the rotatable component 108 rotates relative to the stationary component 104. Each of the first coil 140 and the second coil 144 can comprise multiple turns of conductive wire wound in a configuration that maximizes the mutual inductance between the coils while accommodating the physical constraints of the rotational interface. The spacing between the first coil 140 and the second coil 144 can be minimized to improve coupling efficiency while maintaining sufficient clearance to permit free rotation of the rotatable component 108. In some configurations, ferromagnetic core materials can be incorporated with one or both of the first coil 140 and the second coil 144 to concentrate the magnetic flux and enhance the coupling coefficient between the coils.

More specifically, the power conversion module 138 directs current to the first coil 140 of the stationary component 104, generating a magnetic field. The magnetic field induces current in the second coil 144 of the rotatable component 108, thereby transferring the signal from the first coil 140 to the second coil 144, and thus, from the stationary component 104 to the rotatable component 108. In this way the wireless transfer system can provide necessary power for the operation of any electronic components 120 supported on the rotatable component 108. The power conversion module 138 can be configured to generate an alternating current at a predetermined frequency selected to optimize power transfer efficiency based on the inductance values of the first coil 140 and the second coil 144 and the coupling coefficient therebetween. The operating frequency can be selected to achieve resonant or near-resonant operation, which can improve power transfer efficiency compared to non-resonant configurations. The power conversion module 138 can include switching elements such as transistors or MOSFETs arranged in a half-bridge or full-bridge configuration to generate the alternating current from a DC power source. In some implementations, the power conversion module 138 can include control circuitry configured to adjust the operating frequency, duty cycle, or amplitude of the alternating current in response to varying load conditions at the electronic component 120. The induced current in the second coil 144 has a magnitude that depends on the mutual inductance between the coils, the frequency of the alternating current in the first coil 140, and the load impedance presented by the electronic component 120 and associated circuitry.

As best shown in FIGS. 2-4, the wireless power transfer system can include a circuit arrangement to facilitate signal transfer between the stationary component 104 and the rotatable component 108. The circuit arrangement comprises two circuits that are linked through magnetic coupling at the coil 140 and the coil 144, enabling contactless energy and signal transmission across the rotational interface. The first circuit 146 is disposed on the stationary component 104 and includes a primary controller 132 and a first power conversion module 138. The primary controller 132 serves as the central processing unit for managing power delivery and communication functions on the stationary side of the wireless transfer system 136. The first power conversion module 138 receives electrical energy from the power source and conditions the energy into a form suitable for wireless transmission through the first coil 140. The second circuit 148 is disposed on the rotatable component 108 and includes the electronic component 120 as well as supporting circuitry for power conditioning and signal processing. The second circuit 148 is configured to receive the wirelessly transmitted energy and convert it into a usable form for the electronic component 120.

The primary controller 132 can send a power signal directly to the power conversion module 138 to initiate power transmission to the rotatable component 108. In some examples, a communication module 152 can be disposed between the power conversion module 138 and the primary controller 132 to facilitate data exchange and control signal processing. The first circuit 146 can include a first communications module, and the second circuit 148 can include a second communications module. The communication module 152 can receive a control signal from the primary controller 132, such as a digital signal containing operational instructions or configuration parameters, and convert the digital signal to an analog signal, such as a modulated current signal, that is supplied to the power conversion module 138. The power conversion module 138 processes the analog signal and generates an AC current signal that is directed through the first coil 140. The AC current signal flowing through the first coil 140 causes the coil to generate a time-varying magnetic field that extends into the space surrounding the coil. The magnetic field generated by the first coil 140 interacts with the second coil 144 through mutual inductive coupling, inducing a corresponding current in the second circuit 148. The magnitude of the induced current depends on factors including the coupling coefficient between the coils, the frequency of the AC current in the first coil 140, and the impedance characteristics of the second circuit 148. In the case of a power signal intended to energize the electronic component 120, the resulting induced current can be supplied directly to the electronic component 120 if the component is configured to operate with AC power, or the induced current can be directed to a rectifier circuit within the power pick-up unit 154 to be converted and supplied as DC current suitable for powering DC-operated electronic components. The rectifier circuit can include filtering components such as capacitors to smooth the rectified output and provide stable DC power to the electronic component 120. In the case of communication or data exchange signals, the induced signal in the second circuit 148 can be directed to the secondary control unit 156 for demodulation and processing. The secondary control unit 156 can extract the data content from the received signal and generate appropriate control outputs for the electronic component 120 based on the received instructions.

On the rotatable component 108 side, the second coil 144 captures the magnetic energy generated by the first coil 140 in the stationary component 104 through mutual inductive coupling. The induced alternating current in the second coil 144 is directed to a power pick-up unit 154 positioned adjacent or integrated with the working component 118. The power pick-up unit 154 can include a rectifier that converts the alternating current (AC) to direct current (DC). The rectifier can be configured as a full-wave bridge rectifier comprising four diodes arranged to convert both half-cycles of the AC waveform into unidirectional current flow. In alternative configurations, the rectifier can be implemented as a half-wave rectifier for simpler applications where efficiency requirements are less stringent. The second circuit 148 can include a second power conversion module to convert the second AC current to a DC current for powering the electronic component 120. The power pick-up unit 154 can further include voltage regulation circuitry to maintain a stable output voltage despite variations in the coupling coefficient between the coils or fluctuations in the load current drawn by the electronic component 120. Such voltage regulation circuitry can include linear regulators for low-noise applications or switching regulators for improved efficiency at higher power levels. The power pick-up unit 154 can also incorporate overvoltage protection circuitry to prevent damage to the electronic component 120 in the event of transient voltage spikes or abnormal operating conditions. Current limiting functionality can be integrated within the power pick-up unit 154 to protect both the power pick-up unit 154 and the electronic component 120 from excessive current draw during fault conditions.

The rectified DC power is supplied to various electronic components 120 (e.g., sensors, LEDs, RFID readers, etc.) attached or adjacent to the working component 118. In some configurations, the power pick-up unit 154 can include energy storage elements such as capacitors or rechargeable batteries to provide temporary power during brief interruptions in the wireless power transfer or to handle peak power demands that exceed the continuous power delivery capability of the wireless transfer system 136.

The rotatable component 108 can also include a communication module 152 and secondary control unit 156 that manages bi-directional data exchange between the stationary component 104 and rotatable component 108. The communication module 152 and the control unit 154 can be positioned within the rotatable component or adjacent or integrated with the electronic components 120. The secondary control unit 156 can include a microcontroller or microprocessor configured to execute firmware that manages the operation of the electronic component 120 based on received commands and local sensor inputs. The secondary control unit 156 can maintain operational state information or execute control routines when communication with the primary controller 132 is temporarily unavailable. Upon receiving incoming signals, the communication module 152 converts the signal into appropriate form to operate the electronic components 120 attached to the working component 118. For example, a digital control signal from the stationary component 104 can be processed and translated into an analog signal. The communication module 152 can employ various modulation techniques to encode data onto the power carrier signal or to transmit data through a separate communication channel. Amplitude modulation, frequency modulation, or phase modulation techniques can be utilized depending on the bandwidth requirements and noise immunity considerations of the particular application. The communication module 152 can also implement error detection and correction protocols to promote reliable data transmission in the presence of electromagnetic interference or signal degradation. In bidirectional communication configurations, the communication module 152 on the rotatable component 108 can modulate the load impedance presented to the second coil 144 to transmit data back to the stationary component 104 through load modulation techniques. In some implementations, the secondary control unit 156 can transmit data from the electronic component 120 to the primary controller 132 by modulating a signal in the second coil 144 that induces a corresponding signal in the first coil 140 for reception by the primary controller 132.

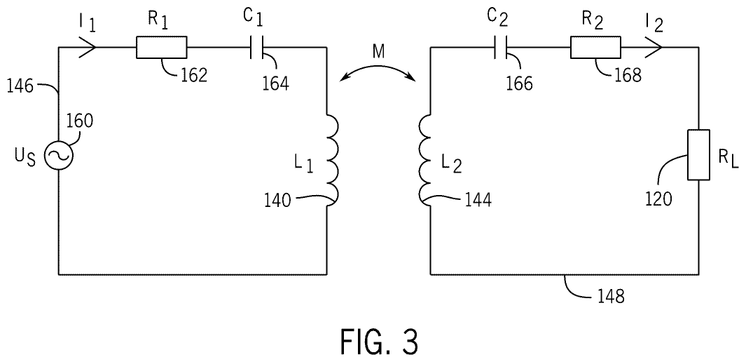

FIG. 3 is a circuit diagram of the wireless transfer system 136 used to deliver signal from the stationary component 104 to the rotatable component 108. Inductive coupling is employed between the first coil 140 and the second coil 144, which enables power transfer without any physical connection. On the stationary component 104 side, the first circuit 146 includes an AC voltage source 160, which supplies an alternating current at a predetermined frequency to drive the system. The frequency of the AC voltage source 160 can be selected based on the inductance values of the coils and the desired power transfer characteristics, with higher frequencies generally enabling more compact coil designs while lower frequencies can reduce switching losses in the power electronics. The AC voltage source 160 is connected to a resistor 162 and a capacitor 164 in series with the first coil 140. The capacitor 164 can be positioned between the resistor 162 and the first coil 140. The resistor 162 regulates the current flowing into the circuit and can limit inrush currents during startup conditions. In some configurations, the resistor 162 can be implemented as a variable resistance element to enable adjustment of the power delivery level. The capacitor 164 maintains circuit stability by compensating for reactive impedance caused by the coil and can be selected to achieve series resonance with the inductance of the first coil 140 at the operating frequency, thereby maximizing current flow and power transfer efficiency. The capacitor 164 can comprise a single capacitor element or multiple capacitors arranged in series or parallel configurations to achieve the desired capacitance value and voltage rating. The first coil 140 generates a time-varying magnetic field when alternating current flows through it, with the magnetic field strength being proportional to the current magnitude and the number of turns in the coil. The magnetic field extends outward from the first coil 140 and serves as the medium for transferring signals wirelessly to the second coil 144 without requiring physical electrical contact. On the rotatable component 108 side, the second coil 144 is positioned coaxially with the first coil 140 to capture the magnetic field and maximize the mutual inductance between the coils. The coaxial positioning ensures that the magnetic flux linkage remains substantially constant regardless of the angular position of the rotatable component 108 relative to the stationary component 104. The second coil 144 induces an alternating current in response to the time-varying magnetic field, with the induced current having a magnitude that depends on the rate of change of the magnetic flux through the coil and the number of turns in the second coil 144. The induced alternating current is then passed through a capacitor 166 and a resistor 168. The capacitor 166 can be positioned between the second coil 144 and the resistor 168, and can be selected to achieve resonance with the inductance of the second coil 144 to maximize power transfer at the operating frequency. The resistor 168 can provide load matching and current limiting functions within the second circuit 148. The alternating current induced in the second coil 144 is rectified by the power pick-up unit 154, which can include a rectifier comprising diodes arranged in a bridge configuration to convert the AC power into DC power suitable for powering the electronic component 120. The rectifier can be followed by filtering capacitors to smooth the rectified output and reduce voltage ripple. The captured energy is supplied to the electronic components 120 attached to the working component 118, such as LEDs, sensors, or other devices requiring electrical power for operation.

FIG. 3 is a circuit diagram of the wireless transfer system 136 used to deliver signal from the stationary component 104 to the rotatable component 108. Inductive coupling is employed between the first coil 140 and the second coil 144, which enables power transfer without any physical connection. On the stationary component 104 side, the first circuit 146 includes an AC voltage source 160, which supplies an alternating current at a predetermined frequency to drive the system. The frequency of the AC voltage source 160 can be selected based on the inductance values of the coils and the desired power transfer characteristics, with higher frequencies generally enabling more compact coil designs while lower frequencies can reduce switching losses in the power electronics. The AC voltage source 160 is connected to a resistor 162 and a capacitor 164 in series with the first coil 140. The capacitor 164 can be positioned between the resistor 162 and the first coil 140. The resistor 162 regulates the current flowing into the circuit and can limit inrush currents during startup conditions. In some configurations, the resistor 162 can be implemented as a variable resistance element to enable adjustment of the power delivery level. The capacitor 164 maintains circuit stability by compensating for reactive impedance caused by the coil and can be selected to achieve series resonance with the inductance of the first coil 140 at the operating frequency, thereby maximizing current flow and power transfer efficiency. The capacitor 164 can comprise a single capacitor element or multiple capacitors arranged in series or parallel configurations to achieve the desired capacitance value and voltage rating. The first coil 140 generates a time-varying magnetic field when alternating current flows through it, with the magnetic field strength being proportional to the current magnitude and the number of turns in the coil. The magnetic field extends outward from the first coil 140 and serves as the medium for transferring signals wirelessly to the second coil 144 without requiring physical electrical contact. On the rotatable component 108 side, the second coil 144 is positioned coaxially with the first coil 140 to capture the magnetic field and maximize the mutual inductance between the coils. The coaxial positioning can help maintain substantially constant magnetic flux linkage regardless of the angular position of the rotatable component 108 relative to the stationary component 104. The second coil 144 induces an alternating current in response to the time-varying magnetic field, with the induced current having a magnitude that depends on the rate of change of the magnetic flux through the coil and the number of turns in the second coil 144. The induced alternating current is then passed through a capacitor 166 and a resistor 168. The capacitor 166 can be positioned between the second coil 144 and the resistor 168, and can be selected to achieve resonance with the inductance of the second coil 144 to maximize power transfer at the operating frequency. The resistor 168 can provide load matching and current limiting functions within the second circuit 148. The alternating current induced in the second coil 144 is rectified by the power pick-up unit 154, which can include a rectifier comprising diodes arranged in a bridge configuration to convert the AC power into DC power suitable for powering the electronic component 120. The rectifier can be followed by filtering capacitors to smooth the rectified output and reduce voltage ripple. The captured energy is supplied to the electronic components 120 attached to the working component 118, such as LEDs, sensors, or other devices requiring electrical power for operation.

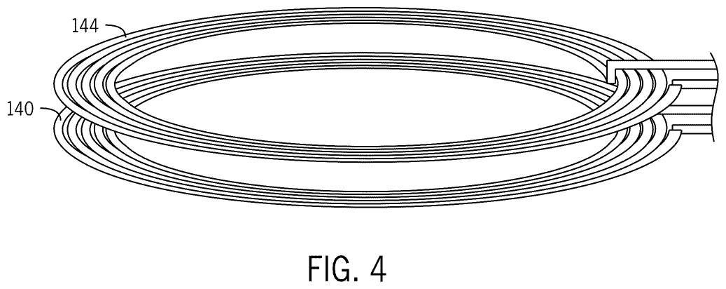

Turning now to FIG. 4, a spatial arrangement of the first coil 140 and the second coil 144 used in the wireless transfer system 136 is shown. The first coil 140, located in the stationary component 104, and the second coil 144, positioned within the rotatable component 108, are aligned in parallel to maximize inductive coupling for transferring signals wirelessly across an air gap defined between the coils. As illustrated, each of the first coil 140 and the second coil 144 includes multiple turns of conductive material arranged in an elongated oval or elliptical configuration. The elongated configuration of the coils can accommodate the physical geometry of the rotational interface between the stationary component 104 and the rotatable component 108 while providing sufficient surface area for effective magnetic flux linkage. The first coil 140 and the second coil 144 are positioned concentrically relative to one another, with the second coil 144 disposed within the perimeter defined by the first coil 140. This concentric arrangement can facilitate passage of the magnetic flux generated by the first coil 140 through the interior region occupied by the second coil 144, thereby maximizing the mutual inductance between the coils. Connection leads extend from each of the first coil 140 and the second coil 144 to interface with their respective circuits, with the leads being routed to minimize interference with the rotational motion of the rotatable component 108. The air gap between the first coil 140 and the second coil 144 is maintained at a distance that permits free rotation of the rotatable component 108 while keeping the coils sufficiently close to achieve acceptable coupling efficiency. In some configurations, the air gap can be in a range of approximately 1 millimeter to 10 millimeters, depending on the power requirements of the electronic component 120 and the physical constraints of the particular power tool application. The parallel alignment of the coils can help maintain substantially uniform magnetic flux linkage regardless of the angular position of the rotatable component 108 relative to the stationary component 104, thereby providing consistent power transfer throughout the full range of rotational motion.

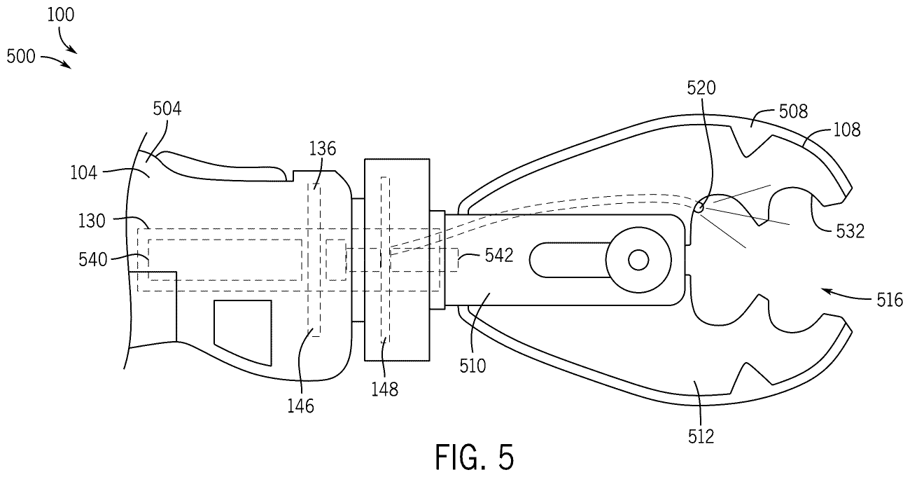

FIG. 5 illustrates an example of the power tool 100 configured as a crimper 500. The crimper 500 includes a housing 504 (e.g., a tool body) corresponding to the stationary component 104 and a working head 508 corresponding to the rotatable component 108. A hydraulic actuator 130 is supported by the housing 504 and extends along a longitudinal axis of the crimper 500. To operate the hydraulic actuator 130, the power tool 100 includes a pump that can provide pressurized hydraulic fluid to the hydraulic actuator 130. The pump can be powered by a battery that is removably coupled to the housing 504. Operation of the hydraulic actuator 130 can operate the working head 508 to perform a desired work operation. The working head 508 includes a yoke 510 that is rotatably coupled to the tool body (e.g., to the housing 504 of the hydraulic actuator 130). The yoke 510 movably supports a pair of jaws 512 so that operation of the hydraulic actuator 130 causes the jaws 512 to move between an open position and a closed position.

To illuminate a work area 516 between the jaws 512, the working head 508 includes a lighting module 520 corresponding to the electronic component 120. As illustrated, the lighting module 520 (e.g., an LED) is positioned on the jaws 512. More specifically, the lighting module 520 is positioned along a crimp surface 532 of the jaws 512 so that light is emitted from between the jaws 512 to illuminate the work area 516, improving visibility and precision during operation. The positioning of the lighting module 520 on the jaws 512 allows the emitted light to be directed toward the workpiece engagement location without obstruction from other portions of the crimper 500, thereby providing enhanced illumination compared to lighting arrangements positioned on the housing 504.

The lighting module 520 can be powered by the battery that is supported on the housing 504. To transmit power to the lighting module 520, the power tool 100 includes the wireless transfer system 136, with the first circuit 146 supported on the tool body and the second circuit 148 supported on the working head 508 (e.g., on the yoke 510), as described above. For example, the first coil 140 of the first circuit 146 is disposed inside the housing 504, and the second coil 144 of the second circuit 148 is disposed inside the working head 508. The first coil 140 and the second coil 144 are positioned to surround the hydraulic actuator 130 and are arranged concentrically with the hydraulic actuator 130 about the longitudinal axis thereof. More specifically, the first coil 140 surrounds a cylinder 540 of the hydraulic actuator 130, and the second coil 144 surrounds a rod 542 of the hydraulic actuator 130. This concentric arrangement positions the first coil 140 radially outward from the cylinder of the hydraulic actuator 130 within the housing 504, while the second coil 144 is positioned radially outward from the rod of the hydraulic actuator 130 within the yoke 510 of the working head 508. The first coil 140 and the second coil 144 are axially aligned with one another along the longitudinal axis of the hydraulic actuator 130 to facilitate mutual inductive coupling therebetween as the working head 508 rotates relative to the housing 504. The concentric positioning of the coils around the cylinder and rod of the hydraulic actuator 130 enables efficient utilization of the available space within the crimper 500 while maintaining consistent magnetic flux linkage throughout the full range of rotational motion of the working head 508.

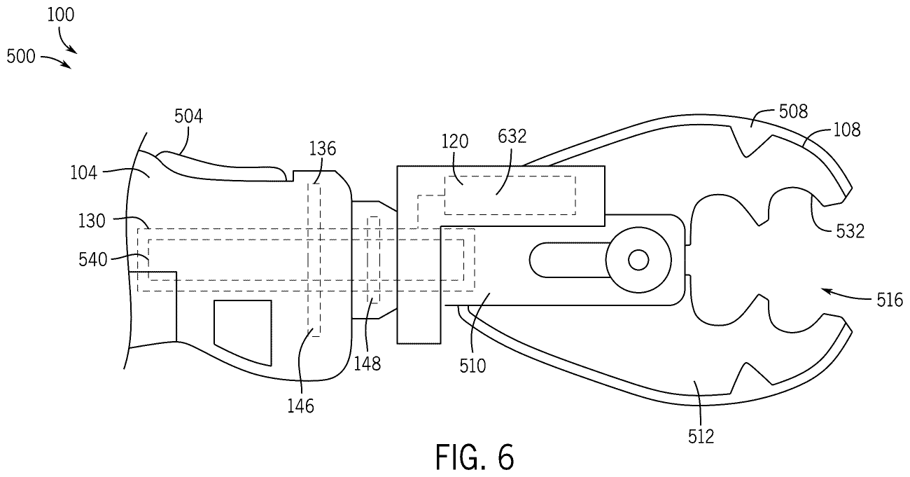

As also discussed above, various types of sensors (e.g., pressure sensors, current sensors, identification tags, etc.) can be incorporated into rotating components. For example, FIG. 6 illustrates the crimper 500 including an identification tag 632 corresponding to the electronic component 120. The identification tag 632 can be an RFID tag, an NFC tag, a Bluetooth transceiver, a Wi-Fi transceiver, or other wireless communication device. The identification tag 632 can serve to enable real-time data exchange between the working head 508 and the tool body (e.g., the primary controller 132 of the power tool 100), as well as external devices or systems. In some configurations, the identification tag 632 can store identification information associated with the working head 508, such as a serial number, manufacturing date, usage history, or calibration data. The identification tag 632 can transmit the stored identification information to the primary controller 132 or to an external device when interrogated by a corresponding reader. In certain implementations, the identification tag 632 can receive updated configuration parameters or operational instructions from the primary controller 132 or from an external device and store the received information for subsequent use. The identification tag 632 can also facilitate automatic recognition of the working head 508 by the primary controller 132, enabling the power tool 100 to automatically configure operational parameters based on the type of working head 508 that is attached. For example, the primary controller 132 can adjust force limits, cycle counts, or other operational settings based on information received from the identification tag 632. In some examples, the identification tag 632 can log operational data such as the number of crimping cycles performed, peak forces experienced, or environmental conditions encountered during use. The logged operational data can be retrieved by the primary controller 132 or by an external device for maintenance tracking or other uses. The wireless transfer system 136 provides power to the identification tag 632 through the inductive coupling between the first coil 140 and the second coil 144, enabling the identification tag 632 to operate without requiring a dedicated battery or other local power source on the working head 508.

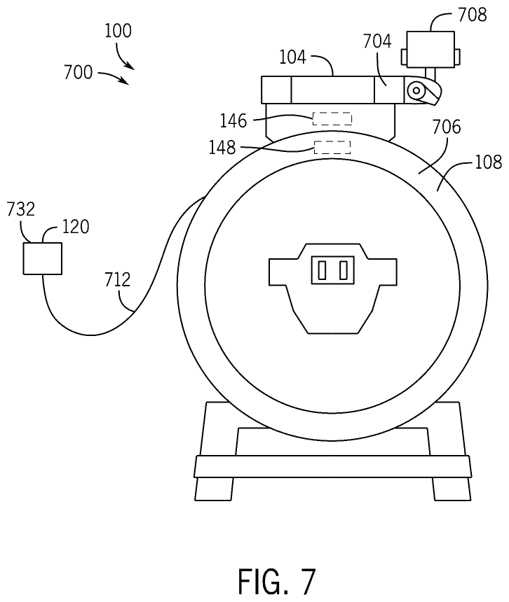

As yet another example, FIG. 7 shows the power tool 100 configured as an inspection camera 700. The inspection camera 700 includes a housing 704 (e.g., a tool body) corresponding to the stationary component 104 and a cable reel 706 corresponding to the rotatable component 108. A controller 708 is supported by the housing 704 and is configured to process image data and manage operation of the inspection camera 700. A cable 712 (e.g., a data cable or inspection probe) can be wound and unwound from the cable reel 706 to extend the reach of the inspection camera 700 into confined spaces, pipes, ducts, or other areas that are difficult to access directly. An image sensor 732 (e.g., a thermal imaging sensor, a visual camera, an infrared sensor, or other imaging device) corresponding with the electronic component 120 can be supported on a free end of the cable 712. The image sensor 732 can capture visual images, thermal images, or other imaging data of the inspection area and transmit the captured data to the controller 708 for display, storage, or analysis. In some configurations, the image sensor 732 can include a lighting element to illuminate the inspection area, thereby improving image quality in dark or poorly lit environments. The image sensor 732 can also include additional sensors such as temperature sensors, humidity sensors, or gas detection sensors to provide supplementary environmental data during inspection operations.

Correspondingly, to transmit data, power, or other signals between the controller 708 and the image sensor 732, the power tool 100 includes the wireless transfer system 136, with the first circuit 146 supported on the housing 704 and the second circuit 148 supported on the cable reel 706. The first coil 140 of the first circuit 146 can be positioned within the housing 704 adjacent to the cable reel 706, and the second coil 144 of the second circuit 148 can be positioned within or on the cable reel 706. The first coil 140 and the second coil 144 can be arranged coaxially about a rotational axis of the cable reel 706 to maintain consistent magnetic flux linkage as the cable reel 706 rotates during winding and unwinding of the cable 712. The wireless transfer system 136 can control transmission of power signals and communication signals between the controller 708 and the image sensor 732, as described above. Power transmitted through the wireless transfer system 136 can be conducted through conductors within the cable 712 from the cable reel 706 to the image sensor 732 at the free end of the cable 712. Similarly, data signals from the image sensor 732 can be transmitted through the cable 712 to the cable reel 706 and then wirelessly transmitted to the controller 708 through the wireless transfer system 136. In other examples, other types of sensors can be supported by the cable 712, such as ultrasonic sensors for detecting wall thickness, magnetic flux leakage sensors for detecting corrosion, or acoustic sensors for detecting leaks or other anomalies.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

Additionally, unless otherwise specified or limited, the terms “about” and “approximate,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A power tool comprising:
a tool body including a power source;
a working component rotatably coupled to the tool body to rotate about an axis relative to the tool body;
an electronic component supported on the working component to rotate with the working component relative to the tool body;
a wireless power transfer system to transmit a power signal from the power source to the electronic component to power the electronic component, the wireless power transfer system including:
a first circuit supported on the tool body and including a first coil and first power conversion module, the first power conversion module powered by the power source to generate a first AC current in the first coil to produce a magnetic field, and
a second circuit supported on the working component and including a second coil, that interacts with the magnetic field and generates a second AC current in the second circuit that powers the electronic component.

2. The power tool of claim 1, wherein the second circuit includes a second power conversion module to convert the second AC current to a DC current.

3. The power tool of claim 1, wherein the electronic component includes at least one of a lighting module or a sensor.

4. The power tool of claim 1, wherein the first circuit includes a first communications module and the second circuit includes a second communications module.

5. The power tool of claim 1, wherein the tool body includes a housing and an actuator supported by the housing, and
wherein the working component includes a yoke rotatably coupled to the tool body and a pair of jaws movably coupled to the yoke, the electronic component being supported on the jaws.

6. The power tool of claim 5, wherein the actuator is a hydraulic actuator defining a longitudinal axis, and wherein the first coil and the second coil are arranged concentrically with the hydraulic actuator about the longitudinal axis.

7. The power tool of claim 6, wherein the hydraulic actuator includes a cylinder and a rod, wherein the first coil surrounds the cylinder and the second coil surrounds the rod.

8. The power tool of claim 6, wherein the first coil and the second coil are axially aligned with one another along the longitudinal axis of the hydraulic actuator.

9. The power tool of claim 1, wherein the tool body includes a housing and a controller supported on the housing, and
wherein the working component includes a cable reel rotatably coupled to a housing and a cable that is wound on the cable reel, the electronic component being supported on a free end of the cable.

10. The power tool of claim 1, further comprising a trigger supported on the tool body, wherein the wireless power transfer system initiates transmission of the power signal in response to actuation of the trigger.

11. The power tool of claim 10, wherein actuation of the trigger causes the first power conversion module to generate the first AC current in the first coil.

12. The power tool of claim 10, further comprising a primary controller supported on the tool body, wherein the primary controller receives an input signal from the trigger and sends a control signal to the first power conversion module to initiate generation of the first AC current.

13. The power tool of claim 10, further comprising an actuator supported on the tool body, wherein actuation of the trigger causes operation of the actuator and transmission of the power signal to the electronic component.

14. A power tool comprising:
a tool body including a power source and a primary controller;
a working component rotatably coupled to the tool body to rotate about an axis relative to the tool body;
an electronic component supported on the working component to rotate with the working component relative to the tool body;
a wireless transfer system to transmit signals between the primary controller and the electronic component, the wireless transfer system including:
a first circuit supported on the tool body and including a first coil, the first circuit receiving a control signal from the primary controller and generating a current in the first coil to produce a magnetic field, and
a second circuit supported on the working component and including a second coil, the second coil interacting with the magnetic field and inducing a current in the second circuit to operate the electronic component based on the control signal from the primary controller.

15. The power tool of claim 14, wherein the second circuit includes a power pick-up unit to convert the induced current to a DC current for powering the electronic component.

16. The power tool of claim 15, wherein the first circuit includes a communication module that receives the control signal from the primary controller and converts the control signal to an analog signal supplied to the first coil.

17. The power tool of claim 16, wherein the second circuit includes a secondary control unit that processes signals received from the first circuit and generates control outputs for the electronic component.

18. The power tool of claim 17, wherein the wireless transfer system is configured for bidirectional communication, the secondary control unit transmitting data from the electronic component to the primary controller by modulating a signal in the second coil that induces a corresponding signal in the first coil for reception by the primary controller.

19. A method of operating a power tool, the method comprising:
rotatably coupling a working component to the tool body to rotate about an axis relative to the tool body;
supporting an electronic component on the working component to rotate with the working component relative to the tool body;
transmitting a first power signal from the power source to the electronic component via a wireless power transfer system to power the electronic component by generating a first AC current in a first coil of a first circuit supported on the tool body using a first power conversion module powered by the power source to produce a magnetic field, the magnetic field interacting with a second coil of a second circuit supported on the working component to generate a second AC current in the second circuit that powers the electronic component.

20. The method of claim 19, further comprising:
transmitting the first power signal when the working component is in a first rotational position relative to the tool body;
rotating the working component from the first rotational position to a second rotational position about the axis relative to the tool body; and
transmitting a second wireless signal from the power source to the electronic component via the wireless power transfer system when the working component is in the second rotational position.
